(19) United States
(12) Patent Application Publication
(10) Pub. No.: US 2006/0062278 A1
(43) Pub. Date: Mar. 23, 2006

(54) Ultrawideband radio transmitter, ultrawideband radio receiver, and ultrawideband radio transmission/reception system

(76) Inventors: Satoru Ishii, Chiba (JP); Yasutaka Koike, Chiba (JP); Ryuji Kohno, Kanagawa (JP)

Correspondence Address: QUARLES & BRADY LLP, 411 E. WISCONSIN AVENUE, SUITE 2040, MILWAUKEE, WI, 53202-4497, US

(21) Appl. No.: 11/219,988

(22) Filed: Sep. 6, 2005

(30) Foreign Application Priority Data
Sep. 6, 2004 (JP) 2004-258522

(51) Int. Cl. H04B 1/69

(52) U.S. Cl. 375/130

(57) ABSTRACT

A device is provided that creates pulse signals for UWB with a simplified circuit and performs radio transmission/reception in ultrawideband. The signal processor converts transmission data into a transmission baseband and then transmits it to the Manchester converter circuit. The Manchester converter circuit creates Manchester codes, which are converted from an L level to an H level with bit data [1] of transmission data, or from an H level to an L level with bit data [0] of transmission data. The Manchester converter circuit drives the monopulse generator circuit, using the output monopulse. The monopulse generator circuit includes series resonator circuit, produces a monopulse signal of transient response, which converts from positive to negative or from negative to positive, in response to the edge of the pulse. The enable control circuit selects a monopulse signal to be transmitted and then transmits as an UWB transmission signal the monopulse signal modulated based on the bit data [1], [0], from the antenna A.

### BACKGROUND OF THE INVENTION

The present invention relates to an ultrawideband radio transmission/reception system, which draws attention in the field of digital radio communication systems. Particularly, the present invention relates to an ultrawideband radio transmitter that utilizes very broad frequency band to transmit high-density digital information and to an ultrawideband radio receiver that utilizes very broad frequency band to transmit high-density digital information.

Recently, frequency resources of radio waves usable in many mobile radio communications are decreasing. When a new radio communication system is intended to introduce, it has become difficult to allocate frequencies, which is not used in the existing radio communication system.

In such a technical field, an ultrawideband radio transmission system has attracted a great deal of attention as the radio technique that effectively recycles the frequency resources.

In the head stream of the ultrawideband radio transmission system (generally referred to as UWB communication system), data signals are converted into signals with very fine pulse widths and are supplied as baseband signals, with no change, to transmission media. For example, when the pulse width of transmission data is set to several nanoseconds, the occupied bandwidth occupied by a series of transmission information becomes several GHz, which corresponds to an occupied frequency band including a carrier frequency.

The UWM radio communication becomes the transmission system having a very wider band than the bandwidth used in the existing radio LANs. Hence, in the radio transmission/reception system of that transmission system, the frequency spectrum is overlapped to the existing frequency regions used for radio transmitters and radio receivers.

However, in the case of the UBW radio transmission/reception system, since the transmission power is distributed over a wide frequency range, the signal levels in the broadly distributed frequency spectrum are very small in each frequency. Accordingly, the frequency spectrum can be handled as signals of noise levels, which do not affect nearly the radio communication in which messages are exchanged in a specific frequency band.

Accordingly, many researches have been done to fully use the existing frequency band as new frequency resources in the radio communication field (refer to Japanese Patent Laid-open Publication No. 2003-204311 and Nikkei Electronics, Jan. 17, 2003, (98 p-121 p)).

In order to realize the UWB communication system explained above, the circuit for processing signal waves over a very high frequency range is required. For example, even if the processing circuit handles small power consumption (or small consumption current), an actual circuit is realized as a large-scale integration (LSI) circuit, thus requiring a high degree technology and difficulty.

In the UWB radio communication system in the monopulse system, the monopulse signal with a pulse width T of one to several tens nS, for example, shown in FIG. 7(a), is subjected to pulse position modulation (PPM) or pulse phase modulation (QPSK), based on the transmission data, and is transmitted as radio waves, with no change.

That is, the pulse signal, shown in FIG. 7(b), obtained by modulating the phase, position or polarity of the monopulse signal based on the transmission digital data, is directly radiated in the atmosphere, or transmission medium, via the wideband antenna. A wideband receiving antenna receives the monopulse signal at a remote spot. The digital reception data is decoded by directly modulating the position or phase of the pulse.

For the monopulse signal waveforms, a high density integrated circuit may be used that includes a ROM table previously storing data for monopulse waveforms and reads out the ROM table with ultra-high speed clocks.

Moreover, a semiconductor integrated circuit for signal processing, which can control the reading timing to modulate the transmission data.

However, actually, the signal processing, which modulates and forms as digital data the very narrow pulse signals, requires a very high technique. The problem is that such a circuit has to be realized with a considerably high difficulty.

### SUMMARY OF THE INVENTION

An ultrawideband radio transmission/reception system of the present invention is made to solve problems explained above.

An object of the present invention is to provide an improved ultrawideband radio transmission/reception system.

In an aspect of the present invention, an ultrawideband radio transmission/reception system comprises the steps of converting transmission digital data into a Manchester code; driving a series resonator using a pulse signal converted into the Manchester code; extracting a transient response pulse using an enable pulse signal synchronized with the clock period of the Manchester code, thus creating a transmission pulse, the transient response pulse being induced at a rising edge and a falling edge of the pulse signal input to the series resonator; and receiving the transmission pulse signal by means of receiver means, which is disposed at a spaced position; whereby the transmission digital data is demodulated.

According to the present invention, an ultrawideband radio transmitter comprises a code converter circuit for converting transmission digital data into a Manchester code; a series resonator driven with a pulse signal code-converted by the code converter circuit; enable control means for extracting a transient response pulse signal induced with a rising edge and a falling edge of the pulse signal input to the series resonator, with a clock signal component synchronized with the Manchester code; and transmission means for transmitting the transient response pulse signal output from the enable control means.

According to the present invention, an ultrawideband radio receiver comprises receiver means for receiving a transient response pulse signal output when a series resonator is driven with a Manchester code; a signal distribution circuit for supplying a transient response pulse signal received by the receiver means to a first delay circuit and a second delay circuit, the first delay circuit and the second delay circuit each having a delay difference being one half the period of a clock signal for the Manchester code; a signal creation circuit for combining a difference between an output of the first delay circuit and an output of the second delay circuit; bit data decision means for deciding the output level of the signal creation circuit; and pulse signal detector means.

According to the present invention, transmission data being information to be transmitted is converted into a Manchester code and then is supplied to, for example, a series resonator, which is constructed with analog elements. The series resonator uses as a monopulse signal in the UWB communication system the signal waveform when transiently responds to a pulse signal. Therefore, the UWB pulse modulated with information can be formed by means of a relatively simple electronic circuit.

The circuit of the present invention performs a predetermined delay process to a transient response pulse signal due to a series resonator upon reception to synthesize the signal and then decides bit data. Therefore, the circuit has a relatively-high detection sensitivity and can decrease the BER (bit error rate).

### BRIEF DESCRIPTION OF THE DRAWINGS

This and other objects, features, and advantages of the present invention will become more apparent upon reading of the following detailed description and drawings, in which:

FIG. 1 is a block diagram schematically illustrating ultrawideband radio equipment, according to an embodiment of the present invention;

FIG. 2 is a signal timing waveform diagram for transmission data employed in the ultrawideband radio transmission/reception system according to the present invention;

FIG. 3 is a circuit diagram illustrating an embodiment of a series resonator;

FIG. 4 is a block diagram schematically illustrating an ultrawideband radio receiver, according to an embodiment of the present invention;

FIG. 5 is a waveform diagram explaining demodulation of received signal waveforms;

FIG. 6 is a waveform diagram explaining a threshold voltage for detecting a received signal waveform; and

FIG. 7 is a diagram explaining a monopulse signal adapted to an UWB communication system.

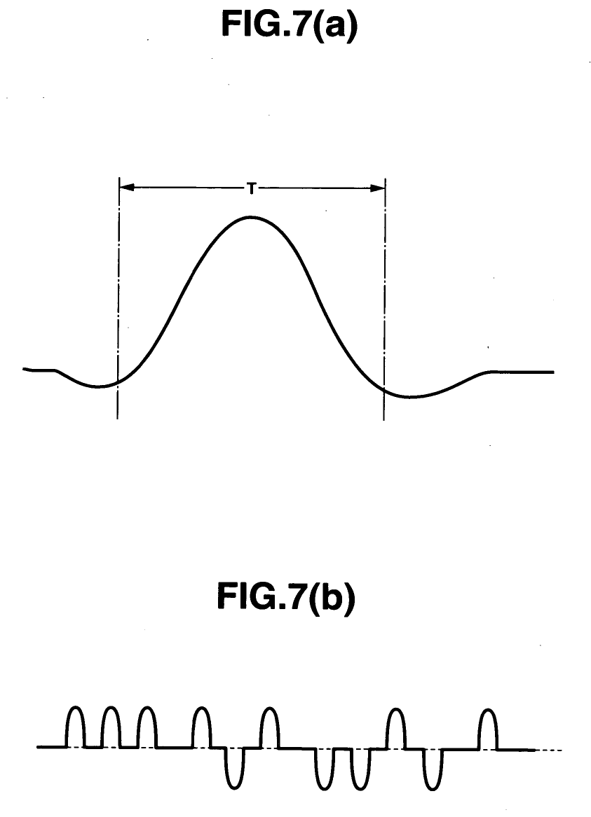

### DESCRIPTION OF THE EMBODIMENTS

In the ultrawideband radio transmission/reception system of the present invention, the signal process, which converts transmission data into a Manchester code, is performed. Then, a series resonator (circuit), which, for exmple, is realized with a lumped constant circuit or a distributed constant circuit, is driven with the coded pulse signal.

The serial resonator transiently responds the input pulse signal at the rising time and the falling time thereof and creates a transient response pulse waveform signal. Therefore, when the transient response pulse waveform signal sequence is extracted with the enable signal formed in synchronous with the clock of a Manchester coded signal, the signal waveform corresponding to the transmission digital data can be obtained. The signal waveform can be transmitted wirelessly or to a wide-band signal line.

The transmitted transient response pulse signal is received and is delayed by a suitable amount, thus being subjected to waveform shaping. By doing so, a positively peaked signal and a negatively peaked signal are created based on the bit data. Thus, the transmitted bit data can be easily demodulated from the received signal.

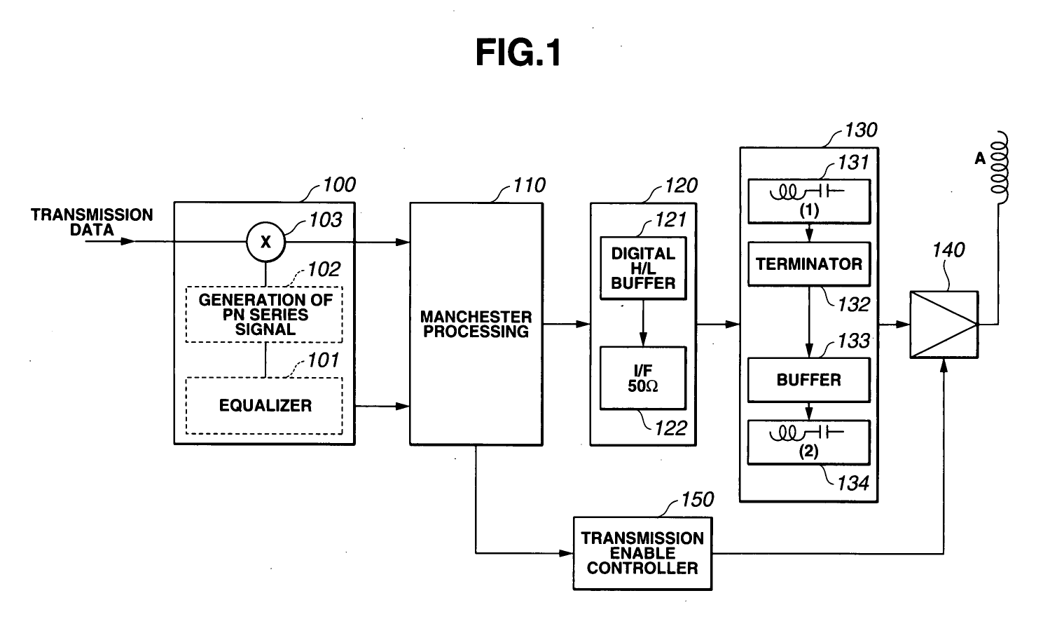

FIG. 1 is a block diagram showing the transmission side that realizes an ultrawide range radio transmission/reception system according to the present invention.

Referring to FIG. 1, numeral 100 represents a signal processor. The signal processor 100 performs various signal processing, including transmission rate conversion, to transmission data, which is obtained by converting transmission information into a digital signal.

In this embodiment, the case where low rate transmission data is output as high rate transmission data will be described below. However, the embodiment may be handle low rate measurement data and mobile communication information for industrial robots.

In the DS communication system where transmission data are distributively processed, the computing unit 103 receives transmission data input to the signal processor 100. The computing unit 103 converts the transmission data into the spread spectrum (SS) code, using the output of the spread signal generator (PN series code generator) 102, which is driven with clocks supplied from the synthesizer 101, which generates a predetermined clock frequency.

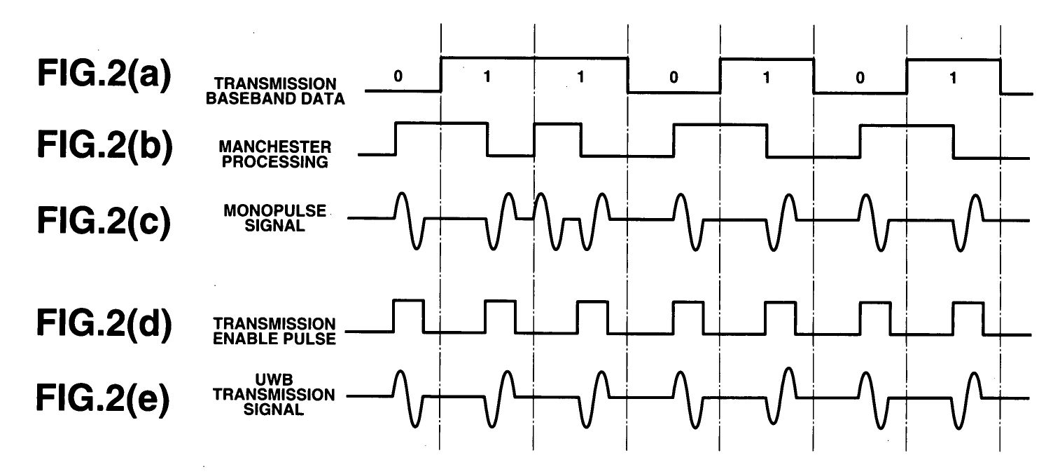

Numeral 111 represents a Manchester code converter circuit. The converter circuit 110 converts, for example, the transmission baseband data (hereinafter, referred to as bit data) (FIG. 2(a)) output from the signal processor 100 into the Manchester coded signal, as shown in FIG. 2(b).

That is, when the bit data of transmission baseband data is, for example, “0”, the logical value is converted into the signal which rises up from an “L” level to an “H” level. When the bit data is “1”, the logical value is converted into the signal which rises up from an “H” level to an “L” level.

The drive signal generator circuit 120 is formed of a digital H/L buffer circuit 121, and an impedance converter circuit 122. The drive signal generator circuit 120 receives the Manchester code signal and converts into the output signal converted into a low impedance (for example, 50Ω series), thus driving the next monopulse generator circuit 130.

The monopulse generator circuit 130 includes a first series resonator 131, a terminator 132, a buffer circuit 133, and a second series resonator 134.

The first series resonator 131 and the second resonator 134 are generally formed of a series resonanatce circuit formed of a coil, a capacitor, and a resistor having a suitable value, or of an analog resonance circuit formed of a distributed constant circuit. By determining a resonance circuit or Q of the resonator to a suitable value, the response characteristics when pulse signal is applied is set to indicate attenuation vibration waveforms.

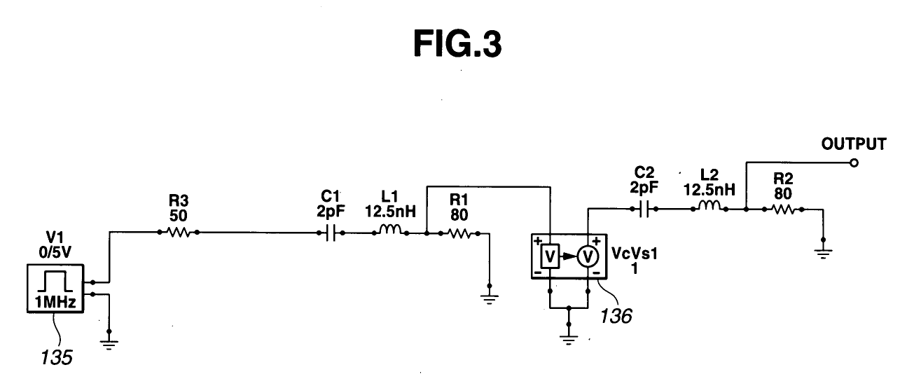

FIG. 3 shows an embodiment of a series resonator in the monopulse generator circuit 130. Numeral 135 is switching means that intermittently supplies, for example, 5 volt, based on the Manchester code.

The first series resonator is formed of a capacitor C1 (2 PF), a coil L1 (12.5 nH), and a resistor R1 (80Ω). The second series resonator is formed of a capacitor C2 (2 PF), a coil L2 (12.5 nH), and a resistor R2 (80Ω).

Numeral 136 represents a terminator and buffer circuit. R3 indicates a power source impedance (50Ω).

Generally, the transient response characteristics of a series resonator, formed of a capacitor C, a coil L, and a resonator R, exhibits a damped vibration waveform when (R²/4L²)<(1/LC) is held, as well known. The damping characteristic can be set with the resistor R.

As to the resonance circuit corresponding to the signal having several tens PS to several tens nS adapted to the UWB radio communication, a microstrip line of a predetermined length can be used as a series resonance element, in place of the capacitance C and the coil L, each being the lumped constant impedance.

In the embodiment including a series resonator formed of a microstrip line, the microstrip line, which is terminated to have a constant impedance of 50Ω and a length of several cm, is formed on a print board through the printing technique. The microstrip line has a series resonance frequency corresponding to a length of λ/4.

A drive circuit to which positive and negative voltages are applied corresponding to the edge of the Manchester code is disposed to the input side. The drive circuit biases the microstrip line and outputs the monopulse signal (a transient response signal), shown in FIG. 2(c), from the terminal of the line.

For the series resonator, a coaxial cable or a waveguide, having characteristics equivalent to the electrical characteristics of the microstrip line, being an element capable of handling as the lumped constant circuit, can be used.

Referring to FIG. 2, the terminator 132 and the buffer 133 supply a transient response pulse, generated when the first series resonator 131 is driven, to the second series resonator 134, and further perform waveform shaping. The monopulse signal formed based on the transient response characteristics of the first series resonator 131 is used to shape the signal waveform more sharply.

In other words, a damped vibrated signal waveform (a transient response pulse signal) is obtained by driving the first series resonator 131 set to a suitable Q value with a Manchester coded pulse signal.

At this time, when the second series resonator 134 is driven via the terminator 132 and the buffer circuit 133 with the transient response pulse signal pulsed by the first series resonator 131, the pulse response characteristic is more sharpened. As a result, the transient response pulse signal with a narrow pulse width can be output as a monopulse signal, as shown in FIG. 2(c).

Numeral 140 represents transmission means for transmitting signals mono-pulsed by the monopulse generator circuit 130. The transmission means 140, which includes an ultrawideband high-frequency amplifier, radiates its output via the antenna A. Numeral 150 represents a transmission enable controller for controlling the output of the monopulsed UWB radio signal.

The transmission enable pulse signal, as shown in FIG. 2(d), selectively gates the monopulse signal representing the transmission bit data of “1” or “0”, in sync with the Manchester coded clock signal. As a result, the transmitter means 140 outputs the UWB modulated signal (QPSK) phase-modulated, based on the bit data “1” or “0”, as shown in FIG. 2(e).

That is, a monopulse to be inverted from a positive peak value to a negative peak value when the bit data is “0” is selected according to the transmission enable pulse signal. A monopulse to be inverted from a negative peak value to a positive peak value when the bit data is “1” is selected and transmitted according to the transmission enable pulse signal.

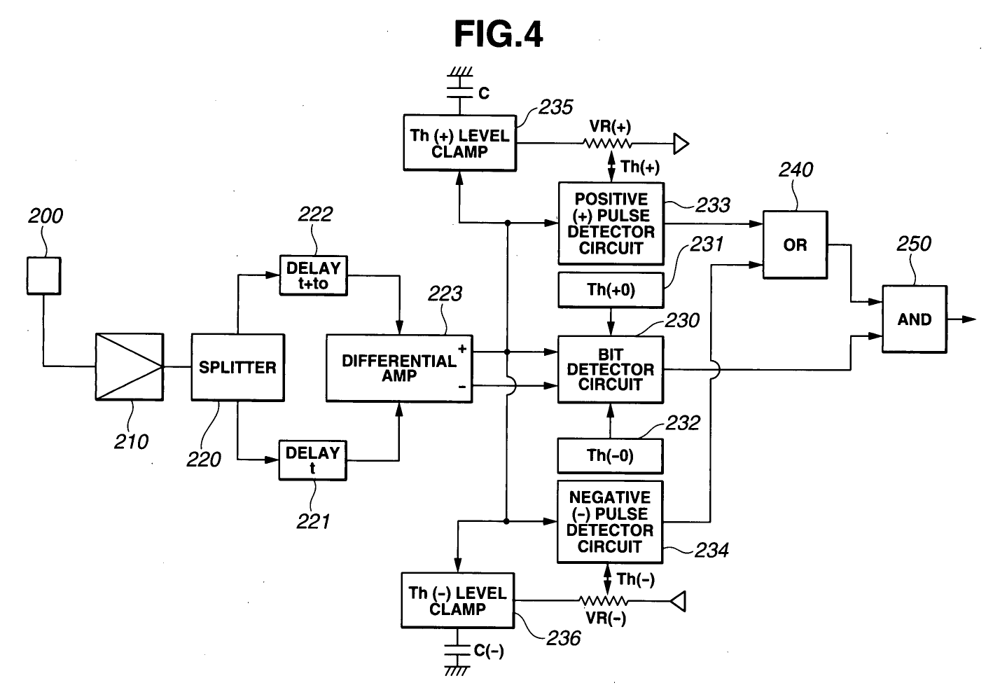

FIG. 4 is a block diagram illustrating an example of a receiver according to the present invention.

Referring to FIG. 4, the low-noise amplifier 210 amplifies, with no change, the radio waves created of the UWB transmission signal shown in FIG. 2(e) received by the ultrawideband antenna 200, so that low frequency band frequency conversion can be performed, if necessary.

The splitter 220 receives the output of the low-noise amplifier 210 and distributes it to the delay circuit 221 and 222.

The splitter 220 and the delay circuits 221, 222 are realized with the transmission line, that is, with the microstrip line patterned on the print board. This leads to large cost reduction.

The delay amount “t” of the first delay circuit 221 is set to “t”. The delay amount “t” of the second delay circuit 222 is set to “t+tP”.

Here, the delay amount “t” is one added by the electrical characteristic of the transmission line and may be set to zero. The delay amount “tp” is set to about half the period of the monopulse, shown in FIG. 2(e), having the bi-phase waveform.

That is, the receiver of the present embodiment is configured so as to make demodulated waveforms through differential reception.

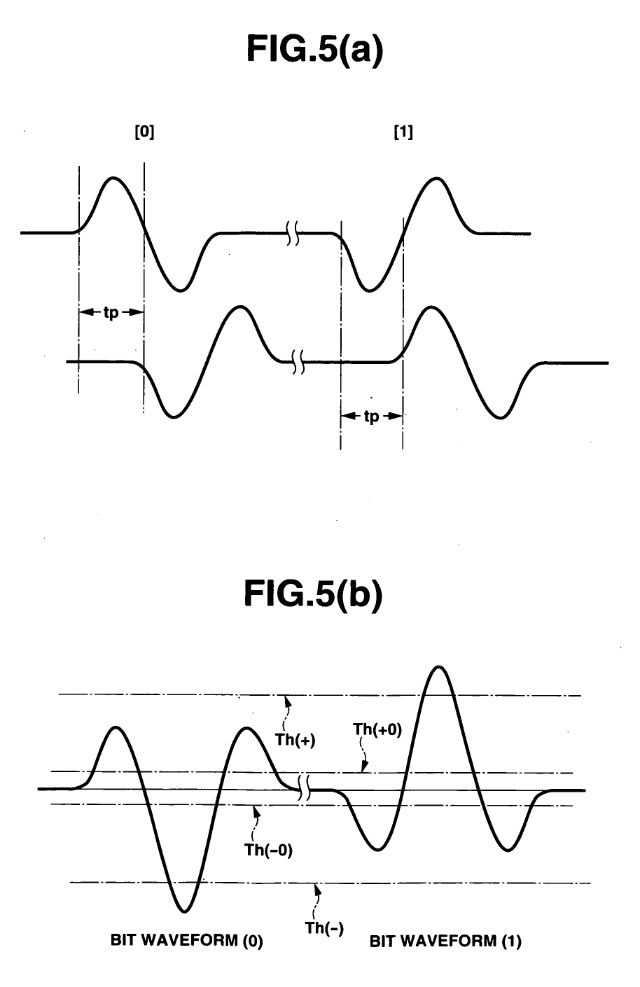

The differential amplifier 223 receives two outputs of the delay circuits 221 and 222, between which the delay difference is “tp”, and adds them, with one signal inverted. The state is shown in FIG. 5.

As shown in FIG. 5(a), the monopulse signal representing the bit data of “0” is separated by means of the splitter 220. One signal is inverted and delayed by tp. The combined waveform is converted into the signal waveform, such as the bit waveform (0), having a negative peak value, as shown with (b).

Moreover, in the monopulse signal representing the bit data of “1”, one signal is inverted by means of the delay circuits 221, 222 and delays by tp. The delay signal is combined by means of the differential amplifier 223. As shown in FIG. 5(b), the signal waveform, being the bit waveform (1) having the positive peak value, is output.

Hence, the positive (+) peak value and the negative (−) peak value of the monopulse reception waveform can be effectively utilized by disposing the delay means and the differential amplifier. As a result, the SN ratio can be simply increased by 6 dB.

The output of the differential amplifier 223 is supplied to the bit detector circuit 230 and the bit detector 230 compares 0-level outputs of the threshold voltage generators 231 and 232.

As shown in FIG. 5(b), the zero-level threshold voltage generator 231 outputs a positive voltage Th(+0), considerably close to zero level, and the zero-level threshold voltage generator 232 outputs a negative voltage Th(−0), considerably close to zero level. By doing so, it is preferable to detect the bit data “1” and “0”, without detecting noise levels.

The differential amplifier 223 supplies its output to the positive (+) pulse decision detector circuit 233 and the negative (−) pulse decision detector circuit 234.

The positive (+) pulse decision detector circuit 233 receives the threshold voltage Th(+) via the adjustable variable resistor VR(+), based on the output of the peak detector circuit 235, which obtains a positive peak value of the output of the differential amplifier. The negative pulse decision detector circuit 234 receives the threshold voltage Th(−) via the adjustable variable resistor VR(−), based on the output of the peak detector circuit 236, which obtains a negative peak value of the output of the differential amplifier 223.

The peak detector circuit is disposed to reduce the influence of fading due to shadowing or multi-path.

That is, in the UWB radio system, the bit rate is fast, that is, several Gbps to several hundreds Mbps but the period of fading due to the multi-path is slow, likewise the conventional radio system.

For this reason, a high-speed charging circuit is prepared and is charged with the pulse height value of the UWB monopulse to detect the peak level. The discharging time constant is set to be the time constant at which the circuit suitably operates to the fading period. Thus, the threshold voltage Th (+)(−) for detecting the presence or absence of the UWB pulse is set.

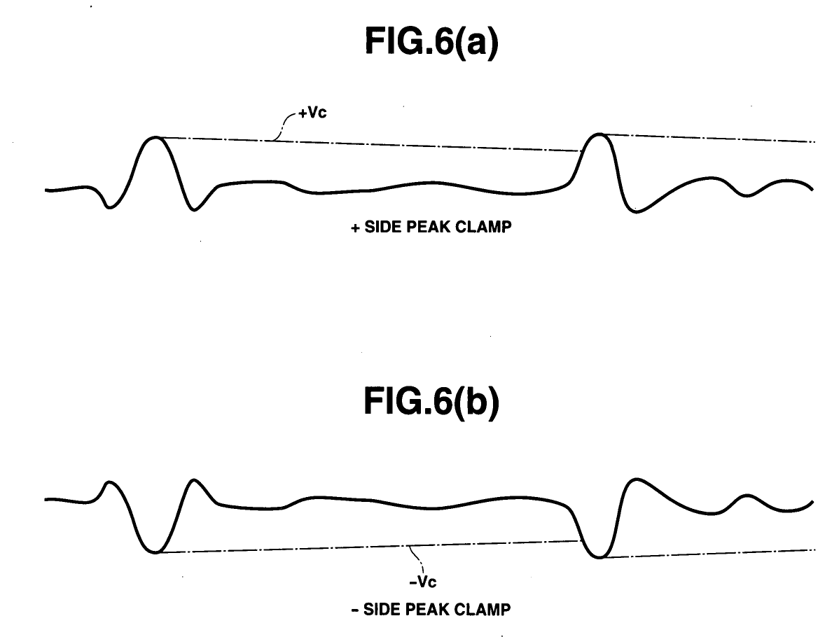

As shown in FIG. 6, the peak detector circuit 235 outputs the voltage +Vc, which is obtained by rectifying the positive peak value of the monopulse signal and holding the peak value for a predetermined period by the time constant circuit including a capacitor. The peak detector circuit 236 outputs the voltage −Vc, which is obtained by rectifying and holding the negative peak value of the monopulse signal. The positive (+) pulse detector circuit 233 produces the threshold voltage Th(+) based on the voltage +Vc while the negative (−) pulse detector circuit 234 produces the threshold voltage Th(−) based on the voltage −Vc.

As a result, as shown, for example, with chain lines in FIG. 5(b), the presence or absence of the pulse signal based on the transmission data can be decided with the signal having the threshold voltage Th(+) or more or with the signal having below the threshold voltage Th(−) or less.

The logical OR circuit 240 receives the output of the positive (+) pulse detector circuit 233 and the negative (−) pulse detector circuit 234 and inputs its output to the bit data detector circuit 250, which is formed of AND circuits.

In the data decision process, the positive pulse detector circuit 233 and the negative pulse detector circuit 234 first decide the presence or absence of the received monopulse signal. When it is decided that there is data, the output “1”, “0” of the bit data detector circuit 230, which is input to the logical AND circuit, is detected as true data.

In the ultrawideband radio transmission/reception system according to the present invention, as seen in the UWM radio transmission/reception system, the narrow monopulse signal of several tens pS to several tens nS does not be required to create by means of the semiconductor integrated circuit. For example, the microstrip line formed of printed wiring conductors overlying a print board is driven with Manchester coded pulse signals. The transient response pulse signal outputted thus is directly transmitted as a transmission signal in the UWB radio system. Therefore, an ultra wideband radio system can be configured very simply.

Moreover, the monopulse signal adapted for the UWB radio system according to the present invention employs the modulation system such that after transmission data is converted into Manchester codes, the bit data is determined in the order of rising and falling thereof. Thus, signal synthesis is performed through utilizing a predetermined delay difference in the reception/demodulaion circuit. Accordingly, there is the advantage in that the detection sensitivity of a transmitted signal waveform increases and the bit error rate (BER) decreases.

Obviously, many modifications and variations of the present invention are possible in the light of the above teachings. It is therefore to be understood that within the scope of the appended claims, the invention may be practiced otherwise than as specifically described.

What is claimed is:

1. An ultrawideband radio transmission/reception system comprising the steps of:
converting transmission digital data into a Manchester code;
driving a series resonator using a pulse signal converted into said Manchester code;
extracting a transient response pulse using an enable pulse signal synchronized with the clock signal of said Manchester code, thus creating a transmission pulse, said transient response pulse being induced at a rising edge and a falling edge of said pulse signal input to said series resonator; and
receiving said transmission pulse by means of receiver means, which is disposed at a spaced position;
whereby said transmission digital data is demodulated.

2. The system as defined in claim 1, wherein said receiver means distributes a received transient response pulse signal to two delay means, each which provides a predetermined delay amount, and demodulates transmission digital data from a combined waveform of output signals from said two delay means.

3. An ultrawideband radio transmitter comprising:
a code converter circuit for converting transmission digital data into a Manchester code;
a series resonator driven with a pulse signal code-converted by said code converter circuit;
enable control means for extracting a transient response pulse signal induced with a rising edge and a falling edge of said pulse signal input to said series resonator, with a clock signal period synchronized with said Manchester code; and
transmission means for transmitting said transient response pulse signal selected by said enable control means.

4. The transmitter as defined in claim 3, wherein said series resonator is formed of a first series resonator and a second series resonator, which are respectively separated by buffer means.

5. An ultrawideband radio receiver comprising:
receiver means for receiving a transient response pulse signal output when a series resonator is driven with a Manchester code;
a signal distribution circuit for supplying a transient response pulse signal received by said receiver means to a first delay circuit and a second delay circuit, said first delay circuit and said second delay circuit each having a delay difference being one half the period of a clock signal for said Manchester code;
a signal creation circuit for combining a difference between an output of said first delay circuit and an output of said second delay circuit;
bit data decision means for deciding the output level of said signal creation circuit; and
pulse signal detector means.

6. The receiver as defined in claim 5, wherein said pulse signal detector means includes a comparison circuit that detects the presence or absence of a monopulse signal received with a threshold level created based on a positive peak voltage and a negative peak voltage of a received transient response pulse signal.
